(19) United States
(12) Patent Application Publication
(10) Pub. No.: US 2026/0287402 A1
(43) Pub. Date: Sep. 24, 2026

(54) OPTICAL ENCODER CAPABLE OF SUPPORTING LARGE OFF-AXIS MOUNTING, REMOTE INSTALLATION, AND HIGH INSTALLATION FLEXIBILITY

(71) Applicant: PixArt Imaging Inc., Hsin-Chu City (TW)

(72) Inventors: Tsung-Fa Wang, Hsin-Chu City (TW); Chen-Lung Liu, Hsin-Chu City (TW)

(73) Assignee: PixArt Imaging Inc., Hsin-Chu City (TW)

(21) Appl. No.: 19/339,254

(22) Filed: Sep. 24, 2025

(30) Foreign Application Priority Data
Mar. 20, 2025 (CN) 202520494017.0

(51) Int. Cl. G01D 5/347

(52) U.S. Cl. CPC G01D 5/34707; G01D 5/3473

(57) ABSTRACT

An optical encoder includes a first code wheel and an image sensor. The first code wheel has a first spiral pattern and a center located on a first rotation axis. The first spiral pattern extends from the first rotation axis to a side edge of the first code wheel. The image sensor senses a change of brightness information reflected from an image within a first partial range of the first code wheel to determine a rotational position of the first code wheel. The rotational position is an absolute position. The optical encoder can readily realize the function of an absolute encoder, support large off-axis mounting and remote installation, and possess high installation flexibility.

### BACKGROUND OF THE INVENTION

### 1. Field of the Invention

This application relates to an optical encoding mechanism, and more particularly to an optical encoder.

### 2. Description of the Prior Art

Generally speaking, the installation positions of traditional incremental-type optical encoders and absolute-type optical encoders are limited due to their architectures. For example, during installation, the sensing circuit of a traditional optical encoder needs to be very accurately aligned with the rotation axis. One sensing circuit of a traditional optical encoder needs to be paired with one rotation axis. Multiple sensing circuits of different traditional optical encoders need to be paired with multiple different axes of rotation respectively.

### SUMMARY OF THE INVENTION

Therefore one of the objectives of the present invention is to provide a novel optical encoder to solve the problems mentioned above.

According to an embodiment of the present invention, an optical encoder is disclosed. The optical encoder comprises a first code wheel and an image sensor. The first code wheel has a first spiral pattern. A center of the first code wheel is located on a first rotation axis. The first spiral pattern extends from the first rotation axis to a side edge of the first code wheel. The image sensor is configured to sense a change of brightness information reflected from an image within a first partial area of the first code wheel to determine a rotational position of the first code wheel. The rotational position is an absolute position.

According to an embodiment of the present invention, an optical encoder is disclosed. The optical encoder comprises a code wheel and an image sensor. The code wheel has a spiral pattern, a center of the code wheel is located on a rotation axis, and the spiral pattern extends from the rotation axis to a side edge of the code wheel. The image sensor is configured to sense a change of brightness information reflected from an image of a partial area of the code wheel to determine the rotational position of the code wheel, and the rotational position is an absolute position.

According to an embodiment of the present invention, an optical encoder is disclosed. The optical encoder comprises a code wheel and an image sensor. The code wheel has a spiral pattern, and the spiral pattern rotates from a center of the code wheel to a side edge of the code wheel. The image sensor is configured to sense a change of brightness information reflected from an image of a partial area of the code wheel to determine the rotational position of the code wheel, and the rotational position is an absolute position.

According to an embodiment of the present invention, an optical encoder is disclosed. The optical encoder comprises a code wheel and an image sensor. The code wheel has a spiral pattern and is located on a rotation axis, and the spiral pattern extends from the rotation axis to a side edge of the code wheel. The image sensor is configured to sense a change of brightness information reflected from an image of a partial area of the code wheel to determine the rotational position of the code wheel, and the rotational position is an absolute position.

According to embodiments of the present invention, the disclosed novel optical encoder can expand the application fields of an image sensor into different gesture and/or encoder applications. By utilizing a simply designed spiral-patterned code wheel, brightness information from the spiral pattern can be accurately reflected. By capturing the shape change, the changes of centroid position, and/or the change of area size of a two-dimensional bright region, the functionality of an absolute encoder can be easily achieved and simultaneously large off-axis mounting can be supported. So long as the face of the code wheel on the rotation axis falls within the field of view of the optical encoder, large off-axis and remote installation can be supported, to achieve high installation flexibility. Moreover, merely a single one optical encoder can be used to detect multiple rotation axes. The detection of multiple rotation axes can be realized within the field of view of the novel optical encoder.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a novel optical encoder according to an embodiment of the present invention.

FIG. 2 is an exemplary schematic diagram showing the first code wheel of FIG. 1 performing a counter-clockwise rotation according to an embodiment of the invention.

FIG. 3 is an exemplary schematic diagram showing the first code wheel of FIG. 1 performing a clockwise rotation according to an embodiment of the invention.

FIG. 4 is a schematic diagram of an example showing the image sensor of FIG. 1 disposed on different planes according to an embodiment of the invention.

FIG. 5 is an exemplary schematic diagram of the first code wheel having an Archimedean spiral pattern according to an embodiment of the present invention.

FIG. 6 is a schematic diagram of a novel optical encoder according to another embodiment of the present invention.

### DETAILED DESCRIPTION

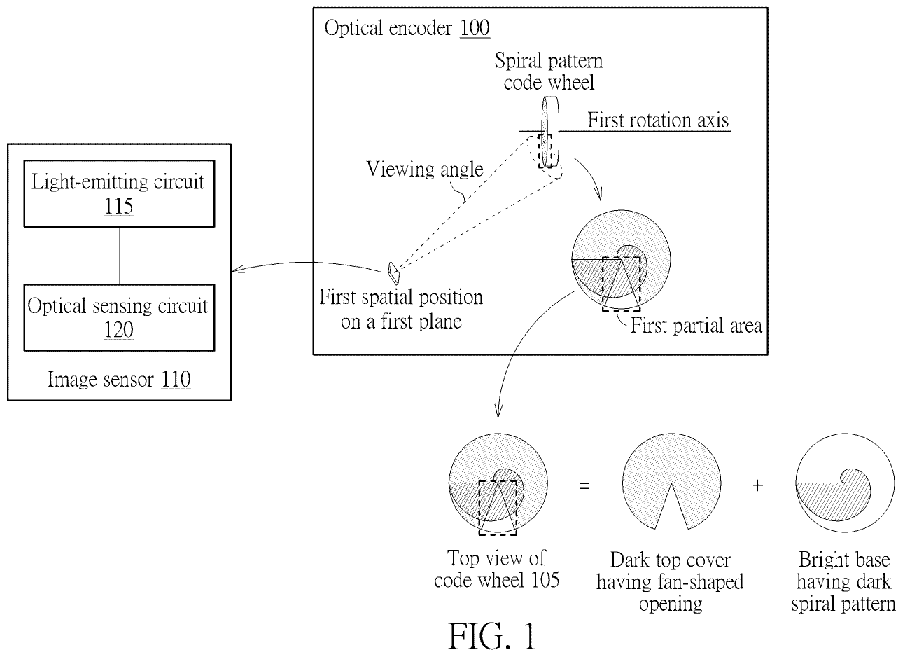

Please refer to FIG. 1. FIG. 1 is a schematic diagram of a novel optical encoder 100 according to an embodiment of the present invention. The optical encoder 100 is for example an optical rotary encoder and at least comprises a first code wheel 105 and an optical sensor such as an image sensor 110.

The first code wheel 105 has a first spiral pattern. The center of the first code wheel is located on a first rotation axis (or the center of the first code wheel 105 is located on the rotation axis). Equivalently, the code wheel 105 is located on the rotation axis. The first spiral pattern starts from the first rotation axis to a side edge of the first code wheel 105. Equivalently, the first spiral pattern rotates from the center of the code wheel (or the rotation axis) to the side edge of the code wheel 105. The image sensor 110 comprises a light-emitting circuit 115 and an optical sensing circuit 120. The image sensor 110 uses the light-emitting circuit 115 to emit lights onto one or more code wheels (e.g., the first code wheel 105) and uses the optical sensing circuit 120 to receive and sense the change of brightness information reflected from an image of a first partial area of the first code wheel 105 at a specific viewing angle to determine the rotational position of the first code wheel 105. The rotational position can be an absolute position.

Specifically, for example, the first code wheel 105 is composed of a top cover 105A and a base 105B. The top cover 105A is for example formed from a simple geometric shape. More specifically, it is, for example, a non-reflective circle such as a dark black circle. The dark black circle includes a fan-shaped opening at its bottom. The fan-shaped opening corresponds to a first partial area of the first code wheel 105. For example, the proportion of the fan-shaped opening is approximately one-eighth to one-sixth of the circumference of the first code wheel 105; however, this is not a limitation of the present invention. The first code wheel 105 can perform clockwise or counter-clockwise rotation by using the first rotation axis. The fan-shaped opening of the top cover 105A does not rotate with the first rotation axis, i.e. its position is fixed.

The upper surface of the base 105B for example has a first spiral pattern, so that the first code wheel 105 is a spiral pattern barcode wheel. The first spiral pattern on the upper surface of the base 105B is for example a simple and distinctively featured curved shape, and it presents a dark shape (e.g., a dark black shape) indicating/resembling a curved crescent shape or a vortex shape. The first spiral pattern begins at one end and gradually curls inward to form a dynamic spiral structure. In other words, the first spiral pattern can be a dark surface and non-reflective pattern, and the other partial areas of the upper surface of the base 105B are bright surface areas and for example are capable of reflecting lights. In different embodiments, the spiral pattern may be bright while the other partial areas may be dark; that is, the reverse implementation is also possible. In this embodiment, the first code wheel 105 includes the first spiral pattern and other bright surface areas. In practice, the material of the upper surface of the base 105B can be a bright surface material, and the dark/black and non-reflective first spiral pattern is then drawn or coated onto this upper surface. The first spiral pattern on the upper surface of the base rotates with the first rotation axis, i.e. its position is not fixed. When the first spiral pattern rotates with the first rotation axis, the other bright surface areas also rotate and are used to reflect the change of brightness information into the image sensor 110, so that the image sensor 100 can determine the rotational position of the first code wheel 105 accordingly.

For example, in one embodiment, the image sensor 110 is used for determining the rotational position, rotational angle, and rotation direction of the first code wheel 105 according to a shape change of a two-dimensional bright surface area corresponding to the change of brightness information. Alternatively, in an embodiment, the image sensor 110 is used for determining the rotational position, rotational angle, and rotation direction of the first code wheel 105 according to a change of a centroid of a two-dimensional bright surface area corresponding to the change of brightness information. Alternatively, in an embodiment, the image sensor 110 is used for determining the rotational position, rotational angle, and rotation direction of the first code wheel 105 according to a change of the area of a two-dimensional bright surface area corresponding to the change of brightness information.

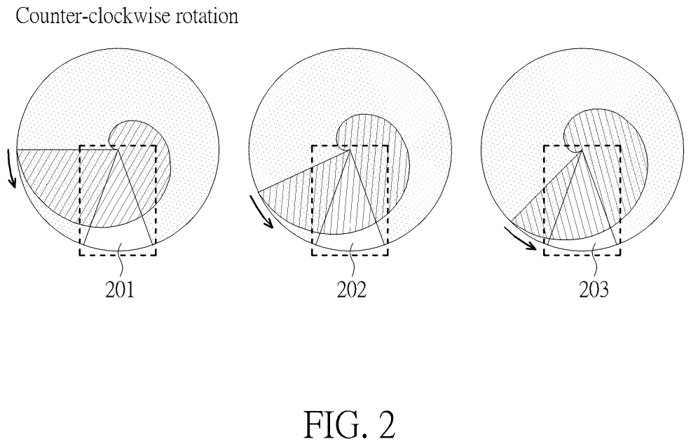

FIG. 2 is an exemplary schematic diagram showing the first code wheel 105 of FIG. 1 performing a counter-clockwise rotation according to an embodiment of the invention. As shown in FIG. 2, from left to right, when the first code wheel 105 rotates counter-clockwise, the two-dimensional bright surface area 201 for example transforms into the two-dimensional bright surface area 202, and subsequently the two-dimensional bright surface area 202 transforms into the two-dimensional bright surface area 203. The two-dimensional bright surface area generates unique and different shape changes, generates unique and different changes of the centroid position, and/or generates unique different and changes of the area size in response to the change of rotational position of the first rotation axis, so that the image sensor 110 can determine the absolute rotational position, rotational angle, and rotation direction of the first code wheel 105 based on the sensed unique and different shape changes, unique and different changes of the centroid position, and/or unique and different changes of the area size of the image (i.e., the two-dimensional bright surface area).

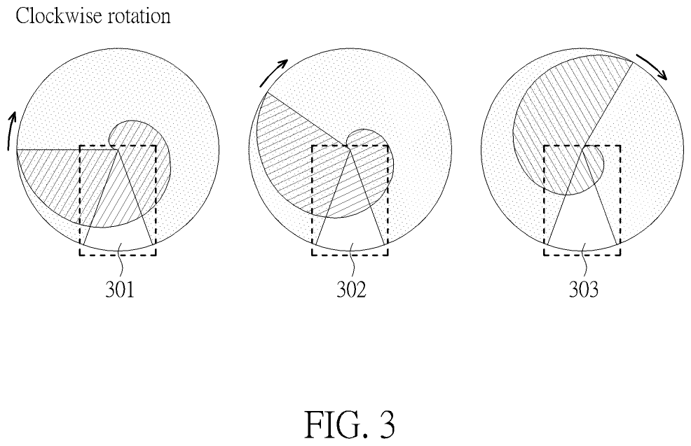

FIG. 3 is an exemplary schematic diagram showing the first code wheel 105 of FIG. 1 performing a clockwise rotation according to an embodiment of the invention. As shown in FIG. 3, from left to right, when the first code wheel 105 rotates clockwise, the two-dimensional bright surface area 301 for example transforms into the two-dimensional bright surface area 302, and subsequently the two-dimensional bright surface area 302 transforms into the two-dimensional bright surface area 303. That is to say, the two-dimensional bright surface area generates unique and different shape changes, unique and different changes of the centroid position, and/or unique and different changes of the area size corresponding to the rotational position of the first rotation axis, so that the image sensor 110 can determine the absolute rotational position, rotational angle, and rotation direction of the first code wheel 105 based on the sensed unique and different shape changes, unique and different changes of the centroid position, and/or unique and different changes of the area size of the image (i.e., the two-dimensional bright surface area).

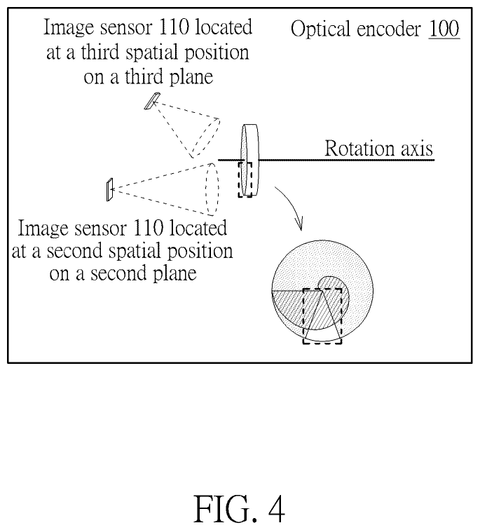

Furthermore, the image sensor 110 can be disposed on different planes. FIG. 4 is a schematic diagram of an example showing the image sensor 110 of FIG. 1 disposed on different planes according to an embodiment of the invention. For example, as shown in FIG. 1, the image sensor 110 is disposed at a first spatial position on a first plane. The image sensor 110 for example is disposed at a position to a side of the first code wheel 105, and this side position is not located directly above, directly below, directly in front of, or directly behind the first code wheel 105. In comparison, as shown in FIG. 4, the image sensor 110 can also be disposed at a second (different) spatial position on a second (different) plane, or it can be disposed at a third/different spatial position on a third/different plane. The second spatial position is a position at another side of the first code wheel 105 and is not located directly above, directly below, directly in front of, or directly behind the first code wheel 105, while the third spatial position is directly above or directly in front of the first code wheel 105. It should be noted that the image sensor 110 can be disposed at any spatial position as long as the image sensor 110 can capture the change of brightness information reflected from the image of the first partial area through its viewing angle to determine the rotational position of the first code wheel 105.

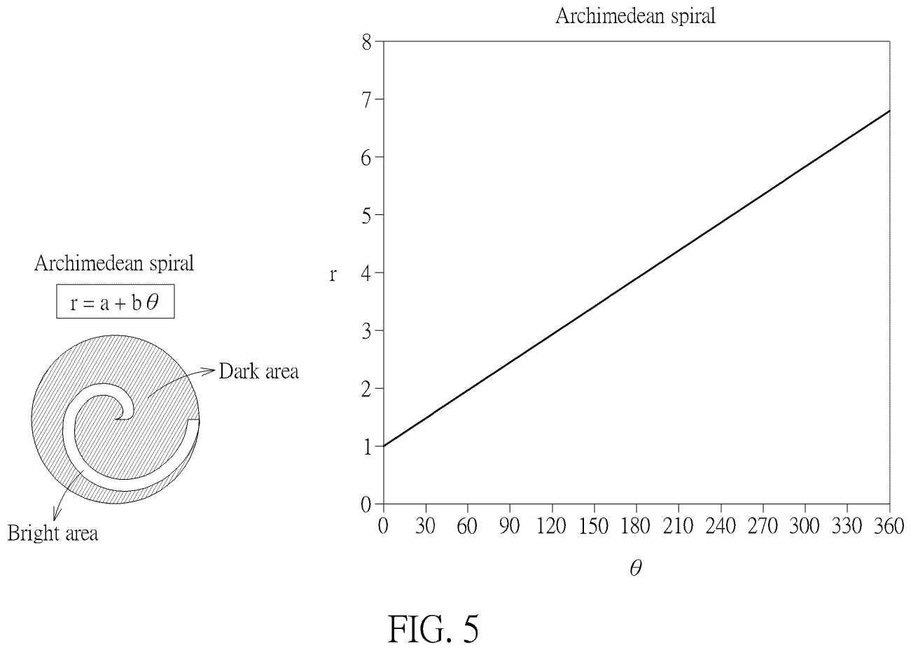

Additionally, the spiral pattern can also have a different pattern type, e.g. an Archimedean spiral pattern. FIG. 5 is an exemplary schematic diagram of the first code wheel 105 having an Archimedean spiral pattern according to an embodiment of the present invention. As shown in the left half of FIG. 5, the upper surface of the first code wheel 105 has an Archimedean spiral pattern and other areas. The Archimedean spiral pattern is a bright-surfaced or light-colored (e.g. white) pattern, and the other areas are associated with dark-surfaced or dark-colored (e.g. black) patterns. The Archimedean spiral is a curve formed by a point moving along a straight line at a constant speed while the line rotates around a fixed point at a constant angular velocity. The characteristic of this spiral is that the distance from any point to the origin is directly proportional to the polar angle corresponding to that point. The Archimedean spiral can be expressed by the mathematical equation:

$$r = a + b * θ ;$$

wherein r is the distance from any point to the origin, θ is the polar angle, a is the initial distance, and b is the step of the spiral (i.e. the increased radius for controlling the rotation of the spiral).

As shown in the right half of FIG. 5, the values at the horizontal axis is the range of a change of the polar angle θ, i.e. different rotational angles of the first code wheel 105. The values at the vertical axis represent r which indicates the distance from any point to the origin (the center origin of the first code wheel 105). That is, when the first code wheel 105 rotates, this indicates the change of brightness information within the first partial area (as shown in FIG. 1) sensed by the image sensor 110, e.g. the distance change between the centroid of the correspondingly sensed two-dimensional bright surface area and the center origin. The distance change has a linear relationship with the rotational angle of the first code wheel 105. Therefore, based on such linear relationship, the image sensor 110 can accurately determine the rotational angle (i.e. the absolute rotational position) of the first code wheel 105 based on the distance change between the centroid of the correspondingly sensed two-dimensional bright surface area and the center origin of the first code wheel 105.

Furthermore, similarly, in an embodiment, the Archimedean spiral pattern on the upper surface of the first code wheel 105 can be a dark-surfaced or dark-colored pattern, and the other areas are bright-surfaced or light-colored patterns. In this situation, the image sensor 110 is used to determine the absolute rotational position, rotational angle, and rotation direction of the first code wheel 105 by sensing the shape changes, the changes of the centroid position, and/or the changes of the area of the two-dimensional dark surface area corresponding to the rotational position of the first rotation axis.

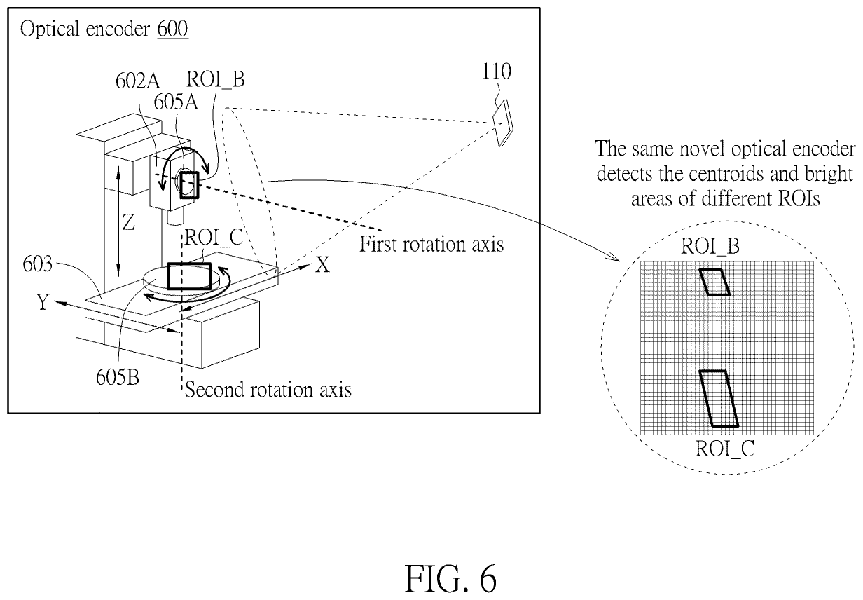

FIG. 6 is a schematic diagram of a novel optical encoder 600 according to another embodiment of the present invention. As shown in FIG. 6, the novel optical encoder 600 comprises a 3D mechanical system 601, a first code wheel 605A, a second code wheel 605B, and an image sensor 110. From a coordinate system perspective, the 3D mechanical system 601 adopts a standard 3D Cartesian coordinate system including X, Y, and Z axes. On the vertical Z-axis, the 3D mechanical system 601 includes a column-type supporting structure, and a first tool head device 602A is disposed above the side of the column-type supporting structure. The first tool head device 602A has the first code wheel 605A, and the center point of the first code wheel 605A corresponds to a first rotation axis which for example is parallel to the Y-axis and can rotate on a horizontal plane. On the horizontal plane formed by the X and Y axes, the 3D mechanical system 601 includes a worktable surface 603. The second code wheel 605B is disposed above the worktable surface 603, and the center point of the second code wheel 605B corresponds to a second rotation axis which for example is parallel to the Z-axis and can rotate on a vertical plane. That is to say, the first rotation axis and the second rotation axis are located on two different three-dimensional planes. Furthermore, the first tool head device (i.e. a top tool head) can move up and down along the supporting structure in response to the rotation of the first code wheel 605A, so that the entire system of the 3D mechanical system 601 can realize the relative precision positioning and motion control of the top tool head. An object to be processed can also be placed on the upper surface of the worktable surface 603 (i.e. above the second code wheel 605B) to achieve relative precision positioning and motion control of the object to be processed in response to the rotation of the second code wheel 605B. For example, the 3D mechanical system 601 can be a CNC machine tool or a 3D printer (but is not limited) and can realize complex machining paths through three-axis linkage. The arrows in FIG. 6 indicate the motion characteristics of the entire system in various directions of movement.

Additionally, to achieve precise detection for the rotational positions of the first code wheel 605A and the second code wheel 605B, the novel optical encoder 600 can merely use a single one image sensor 110 to determine the absolute rotational position of the first code wheel 605A and the absolute rotational position of the second code wheel 605B. Specifically, the first code wheel 605A has a first spiral pattern (e.g. the spiral pattern of FIG. 1 or FIG. 5, not shown in FIG. 6). The center of the first code wheel 605A is located on the first rotation axis. The first spiral pattern starts/extends for example from the first rotation axis to a side edge of the first code wheel 605A. The second code wheel 605B for example also has a spiral pattern (e.g. the spiral pattern of FIG. 1 or FIG. 5, not shown in FIG. 6). The center of the second code wheel 605B is located on a second rotation axis. The second spiral pattern starts/extends from the second rotation axis to a side edge of the second code wheel 605B. The second spiral pattern can be identical to or different from the first spiral pattern. The single one image sensor 110 shown in FIG. 6 can use the same viewing angle to sense the change of brightness information reflected from an image within a first partial area such as ROI_B of the first code wheel 605A to determine the rotational position of the first code wheel 605A, and can simultaneously be used to sense the change of brightness information reflected from an image of a second partial area such as ROI_C of the second code wheel 605B to determine the rotational position of the second code wheel 605B. Both rotational positions can be absolute positions. Since merely a single one image sensor 110 is used to sense the rotational positions of multiple code wheels, the device cost can be reduced significantly. Furthermore, since the absolute rotational positions of multiple code wheels can be sensed and determined as long as the rotational changes of the multiple code wheels can be sensed within the image of the same viewing angle, there is a high degree of flexibility for installing and setting the image sensor 110. It also supports large off-axis mounting and remote installation.

In another embodiment, the first rotation axis and the second rotation axis described in FIG. 6 can also be located at different positions on the same three-dimensional plane. That is, for example, the first code wheel 605A and the second code wheel 605B can be simultaneously placed at adjacent positions on the worktable of the 3D mechanical system 601. The single one image sensor 110 can also use the same viewing angle to sense the rotational positions of the two different code wheels, and both rotational positions can be absolute positions. To simplify the length of the description, the detailed operations are not described for brevity.

It should be noted that, in addition to the embodiment of the aforementioned code wheel 105 using the top cover 105A and the base 105B with a spiral pattern, in other embodiments, encoding of absolute addressing can also be performed by using only the base 105B with the spiral pattern. Taking FIG. 2 as an example, even without the structure of the top cover 105A, since the detection range of the image sensor 110 is limited within the dashed frame in FIG. 2, thus the pattern of the two-dimensional bright surface area 201 detected by the image sensor 110 will still have different shapes, different area sizes, and/or different centroid positions at different rotational angles during the counter-clockwise rotation of the base 105BA. This operation is similar to the concept/operation described above and will not be detailed for brevity. In other words, the code wheel structure depicted in FIG. 1 is an embodiment, and is not intended to be a limitation of the present invention.

Furthermore, the above descriptions are associated with rotating the code wheel 105 to achieve the encoder's 100 architecture. In other embodiments, the image sensor 110 may be rotated while the code wheel 105 itself remains stationary. The concept operation is similar and is not detailed for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical encoder, comprising:
a first code wheel, having a first spiral pattern, a center of the first code wheel being located on a first rotation axis, the first spiral pattern extending from the first rotation axis to a side edge of the first code wheel; and
an image sensor, for sensing a change of brightness information reflected from an image of a first partial area of the first code wheel to determine a rotational position of the first code wheel, the rotational position of the first code wheel being an absolute position of the first code wheel.

2. The optical encoder of claim 1, wherein the first spiral pattern is a bright surface pattern used for reflecting the change of the brightness information to the image sensor, to make the image sensor determine the rotational position of the first code wheel.

3. The optical encoder of claim 2, wherein the image sensor is used for determining the rotational position, a rotational angle, and a rotation direction of the first code wheel based on a shape change of a two-dimensional bright surface area corresponding to the change of the brightness information.

4. The optical encoder of claim 2, wherein the image sensor is used for determining the rotational position, a rotational angle, and a rotation direction of the first code wheel based on a change of a centroid of a two-dimensional bright surface area corresponding to the change of the brightness information.

5. The optical encoder of claim 2, wherein the image sensor is used for determining the rotational position, a rotational angle, and a rotation direction of the first code wheel based on a change of an area of a two-dimensional bright surface area corresponding to the change of the brightness information.

6. The optical encoder of claim 1, wherein the first spiral pattern is a dark surface pattern; the first code wheel comprises the first spiral pattern and other bright surface areas, and the other bright surface areas are used for reflecting the change of the brightness information to the image sensor, to make the image sensor determine the rotational position of the first code wheel.

7. The optical encoder of claim 6, wherein the image sensor is used for determining the rotational position, a rotational angle, and a rotation direction of the first code wheel based on a shape change of a two-dimensional bright surface area corresponding to the change of the brightness information.

8. The optical encoder of claim 6, wherein the image sensor is used for determining the rotational position, a rotational angle, and a rotation direction of the first code wheel based on a change of a centroid of a two-dimensional bright surface area corresponding to the change of the brightness information.

9. The optical encoder of claim 6, wherein the image sensor is used for determining the rotational position, a rotational angle, and a rotation direction of the first code wheel based on a change of an area of a two-dimensional bright surface area corresponding to the change of the brightness information.

10. The optical encoder of claim 1, wherein the image sensor is disposed at a position to a side of the first code wheel, and the position to the side is not located directly above, directly below, directly in front of, or directly behind the first code wheel.

11. The optical encoder of claim 1, further comprising:
a second code wheel, having a second spiral pattern, a center of the second code wheel being located on a second rotation axis, the second spiral pattern extending from the second rotation axis to a side edge of the second code wheel;
wherein the image sensor is used for sensing a change of brightness information reflected from an image of a second partial area of the second code wheel to determine a rotational position of the second code wheel, the rotational position of the second code wheel being an absolute position of the second code wheel.

12. The optical encoder of claim 11, wherein the first rotation axis and the second rotation axis are located on two different three-dimensional planes.

13. The optical encoder of claim 11, wherein the first rotation axis and the second rotation axis are located at different positions on a same three-dimensional plane.

14. An optical encoder, comprising:
a code wheel, having a spiral pattern, a center of the code wheel being located on an rotation axis, the spiral pattern extending from the rotation axis to a side edge of the code wheel; and
an image sensor, for sensing a change of brightness information reflected from an image of a partial area of the code wheel to determine the rotational position of the code wheel, the rotational position of the code wheel being an absolute position of the code wheel.

15. An optical encoder, comprising:
a code wheel, having a spiral pattern, the spiral pattern rotating from a center of the code wheel to a side edge of the code wheel; and
an image sensor, for sensing a change of brightness information reflected from an image of a partial area of the code wheel to determine a rotational position of the code wheel, the rotational position of the code wheel being an absolute position of the code wheel.
